(19) United States
(12) Patent Application Publication
(10) Pub. No.: US 2013/0258262 A1
(43) Pub. Date: Oct. 3, 2013

(54) LIQUID CRYSTAL DISPLAY

(71) Applicants: Jeong Ho LEE, Seoul (KR); Jae Hong PARK, Seoul (KR); Oh Jeong KWON, Hwaseong-si (KR); Sung-Jae YUN, Hwaseong-si (KR); Tae Woon CHA, Seoul (KR); Sang Gun CHOI, Suwon-si (KR)

(72) Inventors: Jeong Ho LEE, Seoul (KR); Jae Hong PARK, Seoul (KR); Oh Jeong KWON, Hwaseong-si (KR); Sung-Jae YUN, Hwaseong-si (KR); Tae Woon CHA, Seoul (KR); Sang Gun CHOI, Suwon-si (KR)

(73) Assignee: SAMSUNG DISPLAY CO., LTD., Yongin-City (KR)

(21) Appl. No.: 13/613,615

(22) Filed: Sep. 13, 2012

(30) Foreign Application Priority Data
Mar. 30, 2012 (KR) 10-2012-0033262

(51) Int. Cl. G02F 1/1337; G02F 1/1343

(52) U.S. Cl. 349/123

(57) ABSTRACT

A liquid crystal display includes a first substrate, a pixel electrode disposed on the first substrate, a first alignment layer disposed on the first substrate and the pixel electrode, a second substrate disposed opposite to the first substrate; a common electrode disposed on the second substrate, a second alignment layer disposed on the second substrate and the common electrode, and a liquid crystal layer disposed between the first substrate and the second substrate, in which the liquid crystal layer includes a plurality of liquid crystal molecules and a chiral dopant, and the first alignment layer and the second alignment layer include polymers formed by photo-polymerization of reactive mesogen.

This application claims priority to Korean Patent Application No. 10-2012-0033262, filed on Mar. 30, 2012, and all the benefits accruing therefrom under 35 U.S.C. §119, the content of which in its entirety is herein incorporated by reference.

### BACKGROUND

(a) Field

Exemplary embodiments of the invention relate to a liquid crystal display.

(b) Description of the Related Art

A liquid crystal display, which is one of the most widely used types of flat panel displays, typically includes two display panels with field generating electrodes such as a pixel electrode and a common electrode and a liquid crystal layer interposed between the field generating electrodes. The liquid crystal display generates an electric field in the liquid crystal layer by applying voltages to the field generating electrodes, and determines directions of liquid crystal molecules of the liquid crystal layer by the generated electric field, thus controlling polarization of incident light so as to display images.

The liquid crystal display includes a vertically aligned mode liquid crystal display, in which liquid crystal molecules are aligned such that longitudinal axes thereof are vertical to display panels in absence of an electric field.

In the vertically aligned mode liquid crystal display, a method of forming a cutout such as micro slits on a field generating electrode and the like may be employed to improved viewing angle. Since a cutout and a protrusion determine a tilt direction of the liquid crystal molecules, the tilt direction of the liquid crystal molecules may be diversified into several directions by disposing the cutout and the protrusion, thereby widening a viewing angle.

Particularly, a method of forming micro slits in a pixel electrode to configure a plurality of branch electrodes reduces an aperture ratio of a liquid crystal display.

Further, when a pixel area is divided into a plurality of domains, display quality may deteriorate at boundaries of the plurality of domains.

### SUMMARY

Exemplary embodiments of the invention relate to a liquid crystal display with improved viewing angle and rapid response speed, with reduced aperture ratio of the liquid crystal display, and with improved display quality at boundaries of a plurality of domains of a pixel thereof.

An exemplary embodiment of a liquid crystal display includes a first substrate, a pixel electrode disposed on the first substrate, a first alignment layer disposed on the first substrate and the pixel electrode, a second substrate disposed opposite to the first substrate, a common electrode disposed on the second substrate; a second alignment layer disposed on the second substrate and the common electrode; and a liquid crystal layer disposed between the first substrate and the second substrate, in which the liquid crystal layer includes a plurality of liquid crystal molecules and a chiral dopant, and the first alignment layer and the second alignment layer include polymers formed by photo-polymerization of reactive mesogen.

In an exemplary embodiment, pitches of the plurality of liquid crystal molecules of the liquid crystal layer may be in the range of about 10 micrometers (μm) to about 50 micrometers (μm).

In an exemplary embodiment, a thickness of the liquid crystal layer may be about 3.0 μm to about 4.0 μm.

In an exemplary embodiment, the pixel electrode may include a cutout, and the liquid crystal layer corresponding to the pixel electrode may be divided into a plurality of domains by the cutout and edges of the pixel electrode.

In an exemplary embodiment, the liquid crystal molecules of the liquid crystal layer at portions adjacent to surfaces of the first substrate and the second substrate may be arranged substantially vertical to the surfaces of the first substrate and the second substrate when an electric field is not generated in the liquid crystal layer.

In an exemplary embodiment, liquid crystal molecules of the liquid crystal layer may be arranged to have pretilt angles in a direction substantially parallel to a direction toward a central portion of the pixel electrode from a point where the edges of the pixel electrode meet.

According to one or more exemplary embodiment of the invention, the liquid crystal display has an improved viewing angle, increased response speed and increased aperture ratio and transmittance while improving visibility. In such an embodiment, deterioration of display quality at boundaries of a plurality of domains thereof is effectively prevented.

### BRIEF DESCRIPTION OF THE DRAWINGS

The above and other features of the invention will become more apparent by describing in further detail exemplary embodiments thereof with reference to the accompanying drawings, in which:

FIG. 1 is a top plan view of an exemplary embodiment of a liquid crystal display according to the invention;

FIG. 2 is a cross-sectional view taken along line II-II of the liquid crystal display of FIG. 1;

FIG. 3 is an equivalent circuit diagram of an exemplary embodiment of a pixel of a liquid crystal display according to the invention;

FIG. 4 is schematic cross-sectional views illustrating an exemplary embodiment of a process for allowing liquid crystal molecules to have pretilt angles using prepolymers which are polymerized by light such as ultraviolet rays;

FIG. 5 is a top plan view illustrating a pixel area of an exemplary embodiment of a liquid crystal display according to the invention.

FIGS. 6A and 6B are views illustrating alignments of liquid crystal molecules of test cells according to an exemplary experiment;

FIGS. 7A to 7D are views illustrating alignments of liquid crystal molecules of test cells according to another exemplary experiment; and

FIGS. 8A to 8D are views illustrating alignments of liquid crystal molecules of test cells according to another exemplary experiment.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

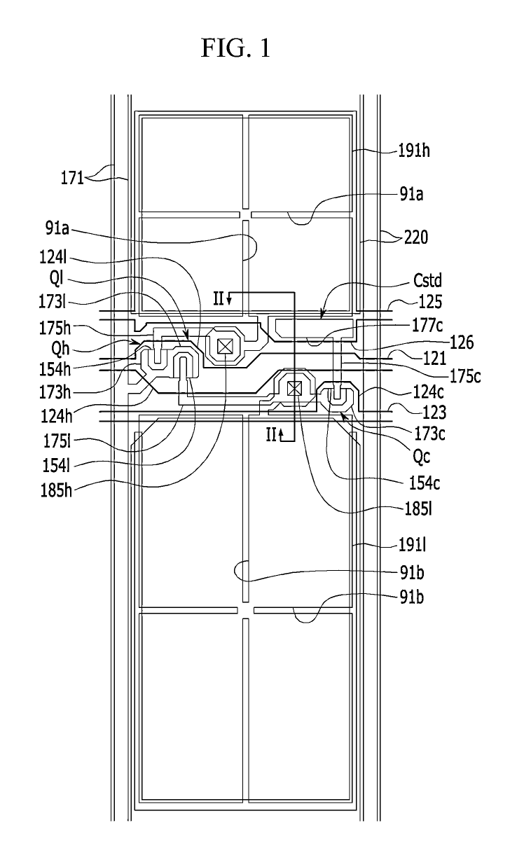

Hereinafter, an exemplary embodiment of a liquid crystal display according to the invention will be described with reference to FIGS. 1 to 3.

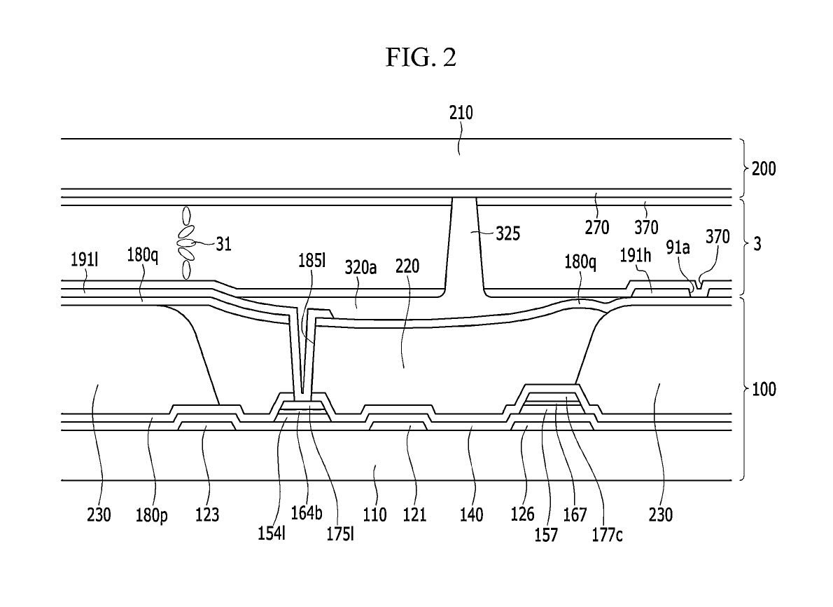

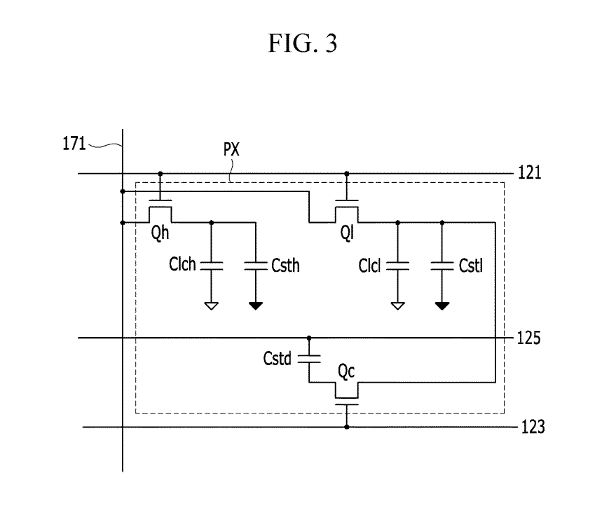

FIG. 1 is a top plan view of an exemplary embodiment of a liquid crystal display according to the invention, FIG. 2 is a cross-sectional view taken along line II-II of the liquid crystal display of FIG. 1, and FIG. 3 is an equivalent circuit diagram showing an exemplary embodiment of a pixel of a liquid crystal display according to the invention.

First, referring to FIG. 3, a liquid crystal display includes signal lines including a gate line 121, a storage electrode line 125, a step-down gate line 123 and a data line 171, and a pixel PX connected to the signal lines.

The pixel PX includes first, second and third switching elements Qh, QI, and Qc, first and second liquid crystal capacitors Clch and Clcl, first and second storage capacitors Csth and Cstl, and a step-down capacitor Cstd. In an exemplary embodiment, each of the first switching element Qh, the second switching element QI and the third switching element Qc may be a thin film transistor (“TFT”), and the first switching element Qh, the second switching element QI and the third switching element Qc may be referred to as a first TFT Qh, a second TFT QI and a third TFT Qc, respectively.

The first and second switching elements Qh and QI are connected to the gate line 121 and the data line 171, respectively, and the third switching element Qc is connected to the step-down gate line 123.

In an exemplary embodiment, the first and second switching elements Qh and QI are three terminal elements such as thin film transistors provided in a lower panel 100, and control terminals thereof are connected to the gate line 121, input terminals thereof are connected to the data line 171, and output terminals thereof are connected to the first and second liquid crystal capacitors Clch and Clcl, respectively, and to the first and second storage capacitors Csth and Cstl, respectively.

In an exemplary embodiment, the third switching element Qc is a three terminal element such as a thin film transistor provided in the lower panel 100, a control terminal thereof is connected to the step-down gate line 123, an input terminal thereof is connected to the second liquid crystal capacitor Clcl, and an output terminal thereof is connected to the step-down capacitor Cstd.

The first and second liquid crystal capacitors Clch and Clcl are formed by overlapping first and second sub-pixel electrodes 191h and 191l, which are connected to the first and second switching elements Qh and QI, and a common electrode 270 of an upper panel 200. The first and second storage capacitors Csth and Cstl are formed by overlapping the first and second sub-pixel electrodes 191h and 191l, and a storage electrode line 125 and a storage electrode (not shown).

The step-down capacitor Cstd is connected to the output terminal of the third switching element Qc and the storage electrode line 125, and is formed by overlapping the storage electrode line 125 provided in the lower panel 100 and the output terminal of the third switching element Qc with an insulator therebetween.

Hereinafter, an exemplary embodiment of the liquid crystal display will be described in greater detail with reference to FIGS. 1 and 2.

Referring to FIGS. 1 and 2, the liquid crystal display includes the lower panel 100 and the upper panel 200, which are disposed opposite to each other, a liquid crystal layer 3 interposed between the lower and upper panels 100 and 200, and a pair of polarizers (not shown) attached to outer surfaces of the upper and lower panels 100 and 200.

First, the lower panel 100 will be described.

The lower panel 100 includes a lower insulation substrate 110. A plurality of gate conductors including the gate line 121, the step-down gate line 123 and the storage electrode line 125 is disposed on the lower insulation substrate 110.

The gate line 121 and the step-down gate line 123 extend substantially in a horizontal direction and transfer gate signals. The gate line 121 includes a first gate electrode 124h and a second gate electrode 124l which protrude upward and downward, and the step-down gate line 123 includes a third gate electrode 124c which protrudes upward. The first gate electrode 124h and the second gate electrode 124l are connected to each other and define a protrusion of the gate line 121.

The storage electrode line 125 extends substantially in a horizontal direction and transmits a predetermined voltage such as common voltage. The storage electrode line 125 includes a storage electrode protruding substantially vertically, a pair of vertical portions extending substantially vertical to the gate line 121, and a horizontal portion connected to ends of the pair of vertical portions. The horizontal portion of the storage electrode line 125 includes a capacitor electrode 126 which extends downward.

A gate insulating layer 140 is disposed on the gate conductors, e.g., the gate line 121, the step-down gate line 123 and the storage electrode line 125.

A plurality of semiconductors, which may include amorphous or crystalline silicon, is disposed on the gate insulating layer 140. The semiconductors extend substantially in a vertical direction and include first and second semiconductors 154h and 154l, which extend toward the first and second gate electrodes 124h and 124l and are connected to each other, and a third semiconductor 154c connected to the second semiconductor 154l. The third semiconductor 154c extends to a fourth semiconductor 157.

A plurality of ohmic contacts is disposed on the semiconductors 154h, 154l and 157. In an exemplary embodiment, the ohmic contacts include a first ohmic contact (not shown) disposed on the first semiconductor 154h, and a second ohmic contact 164b and a third ohmic contact (not shown) disposed on the second semiconductor 154l and the third semiconductor 154c, respectively. The third ohmic contact extends to a fourth ohmic contact 167. In an alternative exemplary embodiment, the semiconductors of the liquid crystal display may be oxide semiconductors, and the ohmic contacts may be omitted.

A plurality of data conductors including a data line 171, a first drain electrode 175h, a second drain electrode 175l and a third drain electrode 175c is disposed on the ohmic contacts, e.g., the second and fourth ohmic contacts 164b and 167.

The data line 171 transfers a data signal and extend substantially in a vertical direction and crosses the gate line 121 and the step-down gate line 123. The data line 171 includes a first source electrode 173h and a second source electrode 173l, which extend toward the first gate electrode 124h and the second gate electrode 124l.

Each of the first drain electrode 175h, the second drain electrode 175l and the third drain electrode 175c include a wide end portion and a rod-shaped end portion. The rod-shaped end portions of the first drain electrode 175h and the second drain electrode 175l are partially surrounded by the first source electrode 173h and the second source electrode 173l. The wide end portion of the second drain electrode 175l extends to a third source electrode 173c, which is bent in a U-like shape. An extension portion 177c of the third drain electrode 175c overlaps the capacitor electrode 126 to form the step-down capacitor Cstd, and a rod-shaped end portion thereof is partially surrounded by the third source electrode 173c.

The first, second and third gate electrodes 124h, 124l, 124c, the first, second, and third source electrodes 173h, 173l and 173c, and the first, second, and third drain electrodes 175h, 175l, and 175c collectively define the first, second, and third TFT Qh, QI and Qc, respectively together with first, second, and third semiconductor islands 154h, 154l and 154c, and a channel of each of the first, second and third TFT Qh, QI and Qc is formed in a corresponding semiconductors of the first, second and third semiconductors 154h, 154l and 154c between the source electrodes 173h, 173l and 173c and the drain electrodes 175h, 175l, and 175c.

In an exemplary embodiment, the semiconductors 154h, 154l and 154c have substantially the same planar shape as the data conductors 171, 175h, 175l and 175c and the ohmic contacts 164l and 167 therebelow, except for channel regions between the source electrodes 173h, 173l and 173c and the drain electrodes 175h, 175l and 175c. In such an embodiment, the semiconductors 154h, 154l and 154c have portions which are exposed without being covered by the data conductors 171, 175h, 175l and 175c in addition to spaces between the source electrodes 173h, 173l and 173c and the drain electrodes 175h, 175l and 175c.

A lower passivation layer 180p, which may include an inorganic insulator such as silicon nitride or silicon oxide, for example, is disposed on the data conductors 171, 175h, 175l and 175c and the exposed portions of the semiconductors 154h, 154l and 154c.

A plurality of color filters 230 is disposed on the lower passivation layer 180p. In an exemplary embodiment, the color filters 230 cover substantially an entire region of the lower passivation layer 180p except for regions where the first thin film transistor Qh, the second thin film transistor QI and the third thin film transistor Qc are positioned. In an exemplary embodiment, the color filters 230 may extend substantially in a vertical direction along gaps between two adjacent data lines 171. Each of the color filters 230 may display one of primary colors such as three primary colors including red, green and blue.

A light blocking member 220 is disposed in a region on the lower passivation layer 180p which is not covered by the color filters 230, and disposed overlapping a portion of the color filters 230. The light blocking member 220 is referred to as a black matrix and prevents light leakage. The light blocking member 220 extends along the gate line 121 and the step-down gate line 123 to extend upward and downward, and includes a first light blocking member covering a region where the first thin film transistor Qh, the second thin film transistor QI and the third thin film transistor Qc are positioned and a second light blocking member extending along the data line 171. A thickness of the light blocking member 220 may be smaller than a thickness of the color filters 230.

An upper passivation layer 180q is formed on the color filters 230 and the light blocking member 220. The upper passivation layer 180q prevents the color filters 230 and the light blocking member 220 from lifting upward and the liquid crystal layer 3 from being contaminated due to an organic material such as a solvent introduced from the color filter 230, thereby preventing a defect such as an afterimage that may occur while driving a screen.

A plurality of first contact holes 185h and a plurality of second contact holes 185l are formed in the lower passivation layer 180p, the light blocking member 220 and the upper passivation layer 180q to expose a wide end portion of the first drain electrode 175h and a wide end portion of the second drain electrode 175l, respectively.

A plurality of pixel electrodes is disposed on the upper passivation layer 180q.

Referring to FIG. 2, each of the pixel electrodes includes a first sub-pixel electrode 191h and a second sub-pixel electrode 191l, which are separated from each other with respect to the gate line 121 and the step-down gate line 123 therebetween and are disposed in an upper portion and a lower portion of a pixel area with respect to the gate line 121 and the step-down gate line 123 to be adjacent to each other in a column direction.

The first sub-pixel electrode 191h and the second sub-pixel electrode 191l receive data voltages from the first drain electrode 175h and the second drain electrode 175l through the first contact hole 185h and the second contact hole 185l. The first sub-pixel electrode 191h and the second sub-pixel electrode 191l receive the data voltages and generate an electric field together with a common electrode 270 of the upper panel 200, thereby determining directions of liquid crystal molecules of the liquid crystal layer 3 between the two electrodes 191 and 270. Luminance of light passing through the liquid crystal layer 3 varies based on the determined directions of the liquid crystal molecules.

In an exemplary embodiment, the first sub-pixel electrode 191h has a first cutout 91a and the second sub-pixel electrode 191l has a second cutout 91b. The first cutout 91a and the second cutout 91b extend from centers of edges of the first sub-pixel electrode 191h and the second sub-pixel electrode 191l to portions adjacent to central portions of the first sub-pixel electrode 191h and the second sub-pixel electrode 191l, and the first sub-pixel electrode 191h and the second sub-pixel electrode 191l may be divided into a plurality of regions by the first cutout 91a and the second cutout 91b.

In an alternative exemplary embodiment, the liquid crystal display may include a cross-shaped opening which is formed on the common electrode 270 instead of the first cutout 91a and the second cutout 91b formed on the first sub-pixel electrode 191h and the second sub-pixel electrode 191l, and a region corresponding to the first sub-pixel electrode 191h and the second sub-pixel electrode 191l may be divided into a plurality of regions by the cross-shaped opening.

The first sub-pixel electrode 191h and the common electrode 270 collectively define the first liquid crystal capacitor Clch together with the liquid crystal layer 3 therebetween, and the second sub-pixel electrode 191l and the common electrode 270 collectively define the second liquid crystal capacitor Clcl together with the liquid crystal layer 3 therebetween to maintain voltages applied thereto even after the first and second thin film transistors Qh and QI are turned off.

The first and second sub-pixel electrodes 191h and 191l overlap the storage electrode line 125 including the storage electrode 129 to define first and second storage capacitors Csth and Cstl, and the first and second storage capacitors Csth and Cstl reinforce the voltage storage capacity of the first and second liquid crystal capacitors Clch and Clcl.

The capacitor electrode 126 and the extension portion 177c of the third drain electrode 175c overlap each other with the gate insulating layer 140 and the semiconductor layers 157 and 167 interposed therebetween to define the step-down capacitor Cstd. In another exemplary embodiment of the invention, the semiconductor layers 157 and 167, which are disposed between the capacitor electrode 126 and the extension portion 177c of the third drain electrode 175c and constitute the step-down capacitor Cstd, may be omitted.

A colored member is disposed on the upper passivation layer 180q. The colored member is disposed in a region corresponding to the light blocking member 220. The colored member extends along the gate line 121 and the step-down gate line 123 upward and downward, and includes a first colored member 320a and a second colored member (not shown) which are disposed along the first light blocking member covering a region, where the first thin film transistor Qh, the second thin film transistor QI and the third thin film transistor Qc are disposed, and along the second light blocking member extending along the data line 171.

The colored member compensates for a difference between heights of the light blocking member 220 and the color filter 230 such that a cell gap of a liquid crystal layer disposed on the color filter 230 and a liquid crystal layer disposed on the light blocking member 220 are substantially uniformly maintained, and the light leakage prevention of the light blocking member 220 is reinforced. In such an embodiment, the colored member compensates for the difference between heights of the light blocking member 220 and the color filter 230, light leakage of an edge of the pixel electrode due to liquid crystal molecules disposed between the light blocking member 220 and the color filter 230, which may not be exactly controlled due to a step between the light blocking member 220 and the color filter 230, is effectively prevented. In such an embodiment, a cell gap on the light blocking member 220 is reduced, and an average cell gap is thereby reduced such that a total liquid crystal amount used in the liquid crystal display may decrease.

An alignment layer 370 is disposed on the pixel electrode 191, an exposed portion of the upper passivation layer 180q and the colored member. In an exemplary embodiment, the alignment layer 370 may be a vertical alignment layer, or an alignment layer which is photo-aligned using a photo-polymerization material.

Next, the upper panel 200 will be described.

The upper panel 200 includes an upper insulation substrate 210, and a common electrode 270 disposed on the upper insulation substrate 210.

The first sub-pixel electrode 191h and the second sub-pixel electrode 191l may be divided into a plurality of sub-regions by the first cutout 91a and the second cutout 91b, and edges of the first sub-pixel electrode 191h and the second sub-pixel electrode 191l.

An alignment layer 370 is disposed on the common electrode 270. The alignment layer 370 may be a vertical alignment layer or an alignment layer which is photo-aligned using a photo-polymerization material.

In an exemplary embodiment, polarizers (not shown) are provided on outer surfaces of the lower and upper display panels 100 and 200. Transmissive axes of the two polarizers may be substantially perpendicular to each other and one of the transmissive axes may be substantially parallel with the gate line 121. In an alternative exemplary embodiment, the polarizer may be disposed on only the outer surface of one of the lower and upper display panels 100 and 200.

In an exemplary embodiment, the liquid crystal layer 3 has a negative dielectric anisotropy, and liquid crystal molecules of the liquid crystal layer 3 are aligned such that longitudinal axes thereof are substantially vertical to the surfaces of the lower and upper display panels 100 and 200 in the absence of an electric field, and are helically twisted to have a predetermined pitch by a chiral dopant included in the liquid crystal layer 3.

The pitch of the liquid crystals by the chiral dopant may be derived from the Gooch&Tarry equation, and particularly, satisfies the following equation:

$$u = \frac{Γ}{2 φ} = \frac{πΔ nd}{λφ} , u = \sqrt{3} .$$

Here, Φ denotes a twist angle of the liquid crystal, and satisfies the equation: Φ=(P/d)2π, where P denotes a pitch and d denotes a cell gap.

In an exemplary embodiment, a thickness of the liquid crystal layer 3 of the liquid crystal display, that is, a cell gap, may be in a range of about 3.0 micrometers (μm) to about 4.0 micrometer (μm), and the pitch of the liquid crystal molecules 31 of the liquid crystal layer 3 may be in a range of about 10 μm to about 50 μm.

In an exemplary embodiment of the invention, the liquid crystal display may further include a spacer 325 for maintaining a cell gap between the lower and upper display panels 100 and 200. In such an embodiment, the spacer 325 may include a material substantially the same as a material included in the colored member.

In an exemplary embodiment, the liquid crystal layer 3 interposed between the lower panel 100 and the upper panel 200 includes liquid crystal molecules 31 having a negative dielectric anisotropy, a chiral dopant and a polymer. The liquid crystal molecules 31 are disposed to be substantially vertical to the lower and upper insulation substrates 110 and 210 while having a predetermined pretilt angle to the substrate surface at an adjacent portion to the lower and upper substrates 110 and 210, and have a shape in which the liquid crystal molecules are helically twisted to have a predetermined pitch by the chiral dopant.

The liquid crystal molecules 31 have pretilt angles by polymers such that longitudinal axes thereof are substantially parallel to directions toward central portions of sub-pixel electrodes 191h and 191l from four portions where edges of the sub-pixel electrodes 191h and 191l, which extend in different directions meet each other by the cutouts 91a and 91b of the pixel electrode and the edges of the sub-pixel electrodes 191h and 191l, and are aligned to be vertical to the surfaces of the lower and upper display panels 100 and 200. Therefore, each of the first and second sub-pixels has four sub-regions including liquid crystals having different pretilt angles.

Hereinafter, an exemplary embodiment of a driving method of the liquid crystal display according to the invention will be described referring back to FIG. 3.

In an exemplary embodiment, when a gate-on signal is applied to the gate line 121, the first switching element Qh and the second switching element QI, which are connected thereto, are turned on. Therefore, a data voltage applied to the data line 171 is applied to the first sub-pixel electrode and the second sub-pixel electrode through the first switching element Qh and the second switching element QI, which are turned on. In such an embodiment, magnitudes of the data voltages, which are applied to the first sub-pixel electrode 191h and the second sub-pixel electrode 191l, are substantially equal to each other such that voltages which are charged in the first and second liquid crystal capacitors Clch and Clcl are substantially equal to each other. Thereafter, when a gate-off signal is applied to the gate line 121 and a gate-on signal is applied to the step-down gate line 123, the first switching element Qh and the second switching element QI are turned off, and the third switching element Qc is turned on. As a result, charges move from the second sub-pixel electrode 191l to the step-down capacitor Cstd through the third switching element Qc. Thus, the voltage charged in the second liquid crystal capacitor Clcl is lowered and the step-down capacitor Cstd is charged. The voltage charged in the second liquid crystal capacitor Clcl is lowered by capacitance of the step-down capacitor Cstd. Thus, the voltage charged in the second liquid crystal capacitor Clcl is lower than the voltage charged in the first liquid crystal capacitor Clch.

In an exemplary embodiment, the voltages charged in the first and second liquid crystal capacitors Clch and Clcl have different gamma curves and the gamma curve of the voltage of a pixel becomes a curved line when the gamma curves are combined. In such an embodiment, the voltages charged in the first and second liquid crystal capacitors Clch and Clcl are controlled such that a combined gamma curve in the front side becomes substantially identical to the reference gamma curve in the front side, which may be predetermined, and a combined gamma curve in the lateral side becomes substantially close to the reference gamma curve in the front side. In such an embodiment, the image data are converted in a pixel as described above such that side visibility is improved.

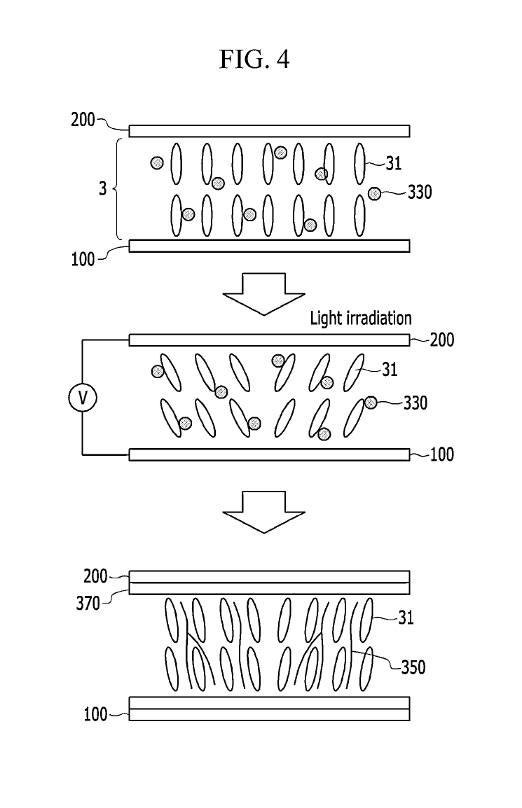

Hereinafter, an initial aligning method for allowing a liquid crystal molecule 31 to have a pretilt angle will be described with reference to FIG. 4. FIG. 4 is schematic cross-sectional views illustrating an exemplary embodiment of a process for allowing liquid crystal molecules to have pretilt angles using prepolymers, which are polymerized by light such as ultraviolet rays.

First, prepolymers 330, for example, monomers, which are cured by polymerization induced by light such as ultraviolet rays, are injected between the lower and upper display panels 100 and 200 together with a liquid crystal material including a chiral dopant. In an exemplary embodiment, the prepolymer 330 may be reactive mesogen which is polymerized by light such as ultraviolet rays.

Then, data voltages are applied to the first and second sub-pixel electrodes 191h and 191l, and a common voltage is applied to the common electrode 270 of the upper panel 200 such that an electric field on the liquid crystal layer 3 is generated between the lower and upper display panels 100 and 200. Thus, the liquid crystal molecules 31 of the liquid crystal layer 3 respond to the electric field, and are inclined substantially parallel to a direction toward a central portion of the pixel electrode 191 from four portions, at which edges of the pixel electrode 191 extending in different directions meet each other, by a horizontal electric field generated by the cutouts 91a and 91b of the pixel electrodes 191h and 191l and the edges of the pixel electrode 191. In such an embodiment, total number of directions, in which the liquid crystal molecules 31 are inclined in a single basic region of the field generating electrode, is four.

In an exemplary embodiment, at a portion adjacent to the edges of the pixel electrodes 191h and 191l and the cutouts 91a and 91b constituting the basic region of the field generating electrode, directors of the liquid crystal molecules are substantially vertical to the edges of the pixel electrodes 191h and 191l and the cutouts 91a and 91b, respectively. In such an embodiment, liquid crystal directors according to the horizontal electric field generated by the edges of the pixel electrodes 191h and 191l and the cutouts 91a and 91b constituting the basic region of the field generating electrode are primarily determined, and secondarily arranged in a direction for minimizing deformation when the liquid crystal molecules meet each other. The secondary arrangement direction corresponds to a direction of vector sum in directions where the directors face. Therefore, the liquid crystal directors are finally substantially parallel with a direction toward central portions of the cutouts 91a and 91b of the pixel electrodes 191h and 191l, that is, the central portions of the pixel electrodes 191h and 191l from four portions where the edges of the pixel electrodes 191h and 191l extending in different directions meet each other. As a result, the total number of directions in which the liquid crystal molecules are inclined in each of the basic regions of the field generating electrode is four.

In an exemplary embodiment, the directors of the liquid crystal molecules 31 in a first region of each of the sub-regions are slanted rightwardly and downwardly to face a central portion from pixel edges, the directors of the liquid crystal molecules 31 in a second region of each of the sub-regions are slanted leftwardly and downwardly to face the central portion from the pixel edges, the directors of the liquid crystal molecules 31 in a third region of each of the sub-regions are slanted rightwardly and upwardly to face the central portion from the pixel edges, and the directors of the liquid crystal molecules 31 in a fourth region of each of the sub-regions are slanted leftwardly and upwardly to face the central portion from the pixel edges.

Then, after a predetermined time, for example, about 500 milliseconds (ms), passes, the liquid crystal molecules 31 are arranged in a twisted shape to have a predetermined pitch under the influence of the chiral dopant included in the liquid crystal layer 3. In such an embodiment, the liquid crystal molecules are helically arranged with respect to the central portions of the pixel electrodes 191h and 191l.

The liquid crystal molecules of the liquid crystal layer 3 arranged in a predetermined direction by the horizontal electric field of the edges of the pixel electrodes 191h and 191l and the cutouts 91a and 91b may collide with each other due to a lack of directionality at the central portions of the pixel electrodes 191h and 191l. In an exemplary embodiment, the liquid crystal display is substantially stabilized by a helical rotation direction under the influence of the chiral dopant.

In an exemplary embodiment, as described above, the liquid crystal molecules 31 of the liquid crystal layer 3 are primarily arranged to have four domains by the horizontal electric field due to the edges of the pixel electrodes 191h and 191l and the cutouts 91a and 91b, and after a predetermined time passes, the liquid crystal molecules 31 of the liquid crystal layer 3 are arranged in a twisted shape to have a predetermined pitch under the influence of the chiral dopant. Thereafter, the prepolymer 330 is polymerized when light, such as ultraviolet rays, is irradiated, thus forming a first polymer 350 and a second polymer 370 as shown in FIG. 4. The first polymer 350 is formed in the liquid crystal layer 3 and the second polymer 370 is formed adjacent to and in contact with the display panels 100 and 200. The alignment direction of the liquid crystal molecules 31 is determined to have the pretilt angles in the above-mentioned direction by the first and second polymers 350 and 370. Therefore, the liquid crystal molecules 31 are arranged to have the pretilt angles corresponding to the four different directions without applying the voltage to the pixel electrodes 191h and 191l and the common electrode 270 which are the field generating electrodes. In such an embodiment, the liquid crystal molecules 31 are arranged along the helical rotation direction under the influence of the chiral dopant even at the central portions of the pixel electrodes 191h and 191l.

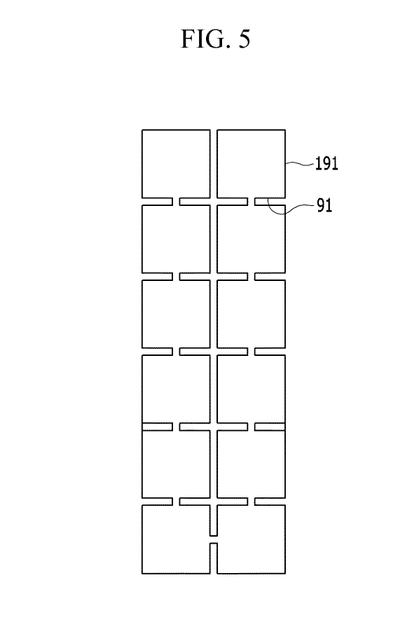

Next, basic regions of a field generating electrode of an exemplary embodiment of a liquid crystal display according to the invention will be described with reference to FIG. 5. FIG. 5 is a top plan view illustrating a pixel area of an exemplary embodiment of a liquid crystal display according to the invention. In FIG. 5, pixel electrodes 191 and cutouts 91 thereof, which constitute the basic regions, are shown.

As shown in FIG. 5, the liquid crystal display may be formed such that a single pixel area has a plurality of basic regions. In one exemplary embodiment, for example, the single pixel area has three basic regions, but the number of basic regions of the single pixel area of the liquid crystal display is not limited thereto and may be changed depending on a size of the liquid crystal display or a cell gap, for example.

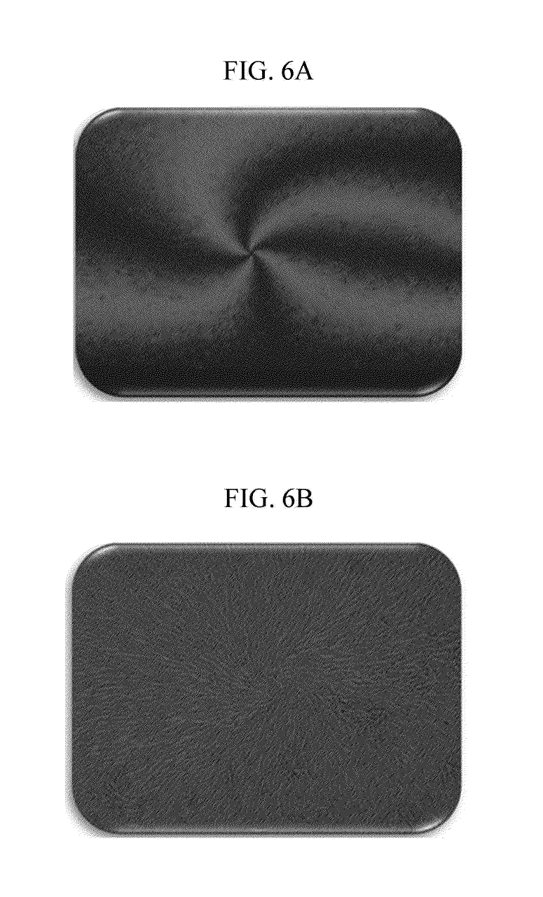

Next, an alignment result of liquid crystal molecules of a liquid crystal display according to an exemplary experiment of the invention will be described with reference to FIGS. 6A and 6B. FIGS. 6A and 6B are views illustrating alignments of liquid crystal molecules of test cells according to an exemplary experiment.

In the exemplary experiment, two test cells were formed including a test cell A where a liquid crystal layer included only a chiral dopant to be aligned and a test cell B where a liquid crystal layer included a prepolymer such as a monomer cured by polymerization induced by light, for example, reactive mesogen together with a chiral dopant and photo-aligned as shown in FIG. 4. In such an experiment, the A and B test cells were subjected to the same conditions except that the prepolymer is included. Further, the concentration of the reactive mesogen in the test cell B reactivity was about 5 weight percent (wt %), the energy of ultraviolet rays for photo-alignment was about 2.4 joules (J), and an ultraviolet ray exposure time was about 20 minutes. The result of the test cell A is shown in FIG. 6A, and the result of the test cell B is shown in FIG. 6B.

As shown in FIG. 6A, when the liquid crystal layer included only the chiral dopant, the alignment directions of the liquid crystal molecules were not uniform at a central portion of the test cell, which may cause an alignment defect portion, for example, reciprocal collision. As shown in FIG. 6B, when the liquid crystal layer included the reactive mesogen together with the chiral dopant and aligned by ultraviolet ray exposure, the central portion of the test cell is arranged along a helical rotation direction of the chiral dopant, and thus the liquid crystal molecules are arranged in each region without reciprocal collision.

In an exemplary embodiment, as described above, the liquid crystal layer includes the reactive mesogen together with the chiral dopant and aligned by ultraviolet ray exposure, and the liquid crystal molecules are thereby arranged in a predetermined direction for each domain at boundaries of a plurality of domains, that is, central portions of pixel electrodes, thereby preventing deterioration of the display quality at the central portions of the pixel electrodes to improve display quality.

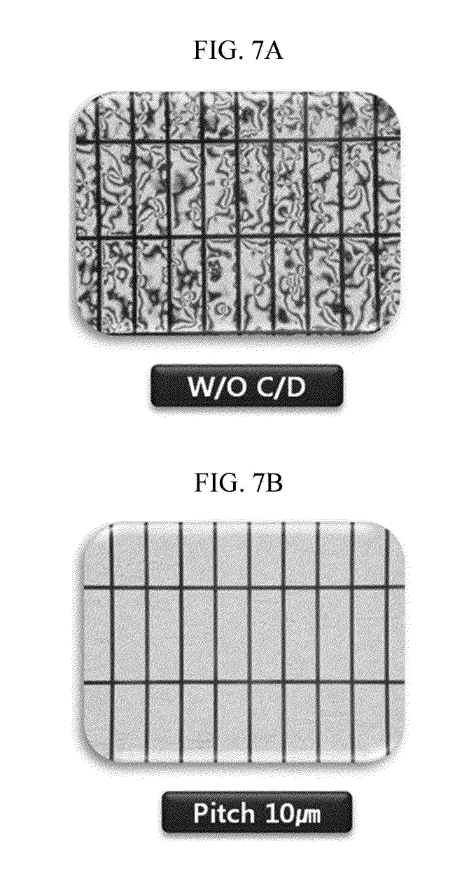

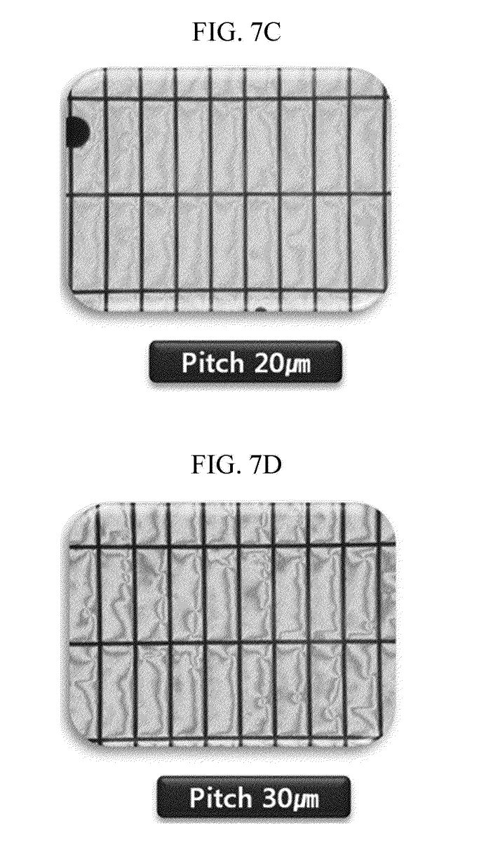

Next, an alignment result of liquid crystal molecules of a liquid crystal display according to another exemplary experiment of the invention will be described with reference to FIGS. 7A to 7D. FIGS. 7A to 7D are views illustrating alignments of liquid crystal molecules of test cells according to another exemplary experiment.

In the exemplary experiment, test cells were formed, where the test cells include a test cell A where a liquid crystal layer included only a chiral dopant and test cells B, C and D where a liquid crystal layer included a prepolymer such as a monomer cured by polymerization induced by light, for example, reactive mesogen together with a chiral dopant and photo-aligned as shown in FIG. 4.

In exemplary experiment, in the test cells B, C, D, pitch values of liquid crystal layers by the chiral dopants were differently set. In the test cell B, a pitch of the liquid crystal layer was about 10 micrometers (μm), in the test cell C, a pitch of the liquid crystal layer was about 20 μm, and in the test cell D, a pitch of the liquid crystal layer was about 30 μm. The other conditions were all the same. The results of the test cells A, B, C and D are shown in FIGS. 7A, 7B, 7C and 7D, respectively.

As shown in FIGS. 7A to 7D, in an exemplary embodiment of the liquid crystal display according to the invention where the liquid crystal layer included the reactive mesogen together with the chiral dopant and aligned by ultraviolet ray exposure, the arrangement of the liquid crystal molecules is stable in each pixel area and a texture due to unstable alignment of the liquid crystal molecules is substantially reduced.

In an exemplary embodiment of the liquid crystal display according to the invention, a pitch of the liquid crystal layer may be in the range of about 10 μm to about 50 μm such that the arrangement of the liquid crystal molecules is stable, and thus a texture may not occur.

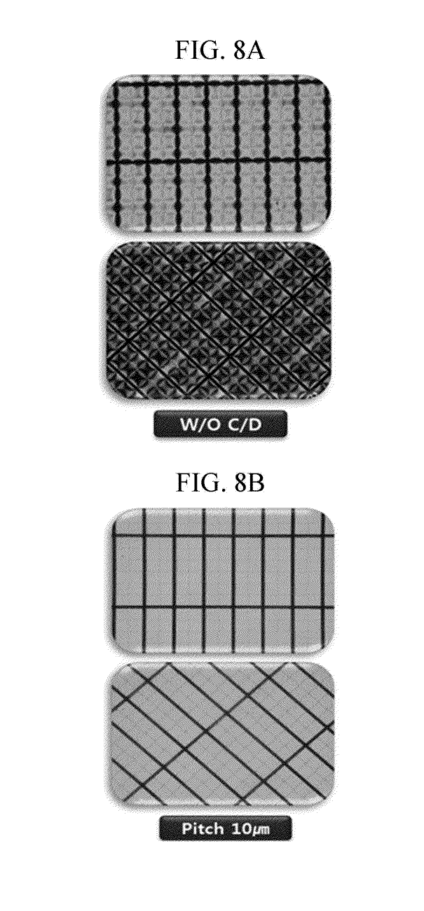

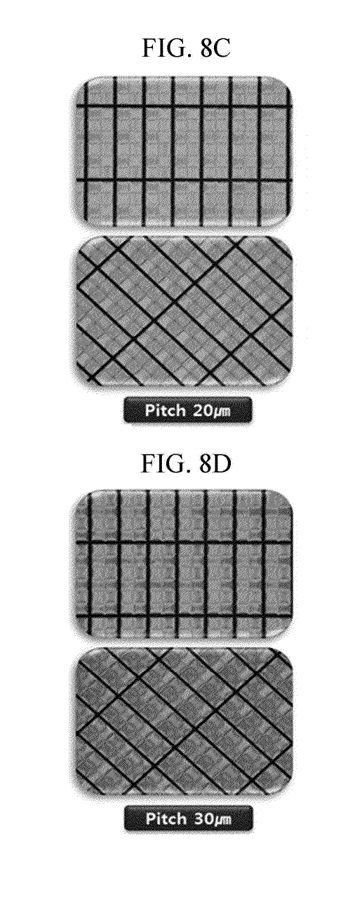

Next, an alignment result of liquid crystal molecules of the liquid crystal display according to another exemplary experiment of the invention will be described with reference to FIGS. 8A to 8D. FIGS. 8A to 8D are views illustrating alignments of liquid crystal molecules of test cells according to another exemplary experiment.

The experiment in FIGS. 8A to 8D was similar to the experiment shown in FIGS. 7A to 7D, and particularly, results at 45 degrees/135 degrees of a polarizer are shown in FIGS. 8A to 8D together with 0 degree/90 degree directions of a polarizer.

In such an experiment, test cells were formed including a test cell A where a liquid crystal layer included only a chiral dopant and is aligned and test cells B, C and D where a liquid crystal layer included a prepolymer such as a monomer cured by polymerization induced by light, for example, reactive mesogen together with a chiral dopant and photo-aligned as shown in FIG. 4. In the test cells B, C and D, pitch values of liquid crystal layers by the chiral dopants were differently set. In the test cell B, a pitch of the liquid crystal layer was about 10 μm, in the test cell C, a pitch of the liquid crystal layer was about 20 μm, and in the test cell D, a pitch of the liquid crystal layer was about 30 μm.

The other conditions were all the same. The results of the test cells A, B, C and D are shown in FIGS. 8A to 8D, respectively.

As shown in FIG. 8A to 8D, compared to the result of the test cell A where the liquid crystal layer included only the chiral dopant, the arrangement of the liquid crystal molecules in the test cells B, C and D, where the liquid crystal layer included the reactive mesogen together with the chiral dopant and aligned by ultraviolet ray exposure, is stable in each pixel area, a texture due to unstable alignment of the liquid crystal molecules did not occur, and the alignment of the liquid crystal molecules is stable where a polarization direction is changed.

As shown in FIGS. 8A to 8D, an exemplary embodiment of the liquid crystal display according to the invention, a pitch of the liquid crystal layer is in the range of about 10 μm to about 50 μm such that the arrangement of the liquid crystal molecules is substantially stable, and thus a texture may not occur.

While this invention has been described in connection with what is presently considered to be practical exemplary embodiments, it is to be understood that the invention is not limited to the exemplary embodiments described herein, but, on the contrary, is intended to cover various modifications and equivalent arrangements included within the spirit and scope of the appended claims.

What is claimed is:

1. A liquid crystal display comprising:
a first substrate;
a pixel electrode disposed on the first substrate;
a first alignment layer disposed on the first substrate and the pixel electrode;
a second substrate disposed opposite to the first substrate;
a common electrode disposed on the second substrate;
a second alignment layer disposed on the second substrate and the common electrode; and
a liquid crystal layer disposed between the first substrate and the second substrate,
wherein the liquid crystal layer includes a plurality of liquid crystal molecules and a chiral dopant, and
the first alignment layer and the second alignment layer include polymers formed by photo-polymerization of reactive mesogen.

2. The liquid crystal display of claim 1, wherein
pitches of the liquid crystal molecules of the liquid crystal layer are in a range of about 10 micrometers to about 50 micrometers.

3. The liquid crystal display of claim 2, wherein
a thickness of the liquid crystal layer is about 3.0 micrometers to about 4.0 micrometers.

4. The liquid crystal display of claim 3, wherein
the pixel electrode includes a cutout, and
the liquid crystal layer corresponding to the pixel electrode is divided into a plurality of domains by the cutout and edges of the pixel electrode.

5. The liquid crystal display of claim 4, wherein
the liquid crystal molecules of the liquid crystal layer at portions adjacent to surfaces of the first substrate and the second substrate are arranged substantially vertical to the surfaces of the first substrate and the second substrate when an electric field is not generated in the liquid crystal layer.

6. The liquid crystal display of claim 5, wherein
the liquid crystal molecules of the liquid crystal layer are arranged to have pretilt angles in a direction substantially parallel to a direction toward a central portion of the pixel electrode from a point where the edges of the pixel electrode meet.

7. The liquid crystal display of claim 2, wherein
the pixel electrode includes a cutout, and
the liquid crystal layer corresponding to the pixel electrode is divided into a plurality of domains by the cutout and the edges of the pixel electrode.

8. The liquid crystal display of claim 7, wherein
the liquid crystal molecules of the liquid crystal layer at portions adjacent to surfaces of the first substrate and the second substrate are arranged substantially vertical to the surfaces of the first substrate and the second substrate when an electric field is not generated in the liquid crystal layer.

9. The liquid crystal display of claim 8, wherein
the liquid crystal molecules of the liquid crystal layer are arranged to have pretilt angles in a direction substantially parallel to a direction toward a central portion of the pixel electrode from a point where the edges of the pixel electrode meet.

10. The liquid crystal display of claim 1, wherein
the pixel electrode includes a cutout, and
the liquid crystal layer corresponding to the pixel electrode is divided into a plurality of domains by the cutout and edges of the pixel electrode.

11. The liquid crystal display of claim 10, wherein
the liquid crystal molecules of the liquid crystal layer at portions adjacent to surfaces of the first substrate and the second substrate are arranged substantially vertical to the surfaces of the first substrate and the second substrate when an electric field is not generated in the liquid crystal layer.

12. The liquid crystal display of claim 11, wherein
the liquid crystal molecules of the liquid crystal layer are arranged to have pretilt angles in a direction substantially parallel to a direction toward a central portion of the pixel electrode from a point where the edges of the pixel electrode meet.

13. The liquid crystal display of claim 1, wherein
the liquid crystal molecules of the liquid crystal layer at portions adjacent to surfaces of the first substrate and the second substrate are arranged substantially vertical to the surfaces of the first substrate and the second substrate when an electric field is not generated in the liquid crystal layer.

14. The liquid crystal display of claim 13, wherein
the liquid crystal molecules of the liquid crystal layer are arranged to have pretilt angles in a direction substantially parallel to a direction toward a central portion of the pixel electrode from a point where the edges of the pixel electrode meet.

15. The liquid crystal display of claim 1, wherein
the liquid crystal molecules of the liquid crystal layer are arranged to have pretilt angles in a direction substantially parallel to a direction toward a central portion of the pixel electrode from a point where the edges of the pixel electrode meet.

16. A method of manufacturing a liquid crystal display, the method comprising:
providing a first substrate;
providing a pixel electrode on the first substrate;
providing a second substrate opposite to the first substrate;
providing a common electrode on the second substrate;
providing a first alignment layer including polymers on the first substrate and the pixel electrode;
providing a second alignment layer including polymers on the second substrate and the common electrode; and
providing a liquid crystal layer between the first substrate and the second substrate,
wherein the liquid crystal layer includes a plurality of liquid crystal molecules and a chiral dopant, and
wherein each of the providing the first alignment layer including the polymer and the providing the second alignment layer including the polymer comprises forming the polymers by photo-polymerization of reactive mesogen.
